(19) United States
(12) Patent Application Publication
(10) Pub. No.: US 2020/0208692 A1
(43) Pub. Date: Jul. 2, 2020

(54) TORQUE TRANSMISSION APPARATUS

(71) Applicant: Logistics and Supply Chain MultiTech R&D Centre Limited, Pok Fu Lam (HK)

(72) Inventors: Kwai Yuen Tiu, Pok Fu Lam (HK); Kin Sau Wong, Pok Fu Lam (HK)

(21) Appl. No.: 16/234,745

(22) Filed: Dec. 28, 2018

(51) Int. Cl. F16D 57/00; F16D 37/02

(52) U.S. Cl. CPC F16D 57/002; F16D 2121/30; F16D 37/02

(57) ABSTRACT

A torque transmission apparatus including: a stationary member, a movable member movable relative to the stationary member in a first direction, and a cavity defined between the stationary member and the movable member for retaining a fluid convertible between a default physical state during which the fluid exerts a force against the movable member in a second direction opposite to the first direction and a temporary physical state during which the force exerted against the movable member is reduced in response to application of a temporary magnetic flux.

### TECHNICAL FIELD

The present invention relates generally to a torque transmission apparatus and more particularly, although not exclusively, relates to a torque transmission apparatus having a movable member movable in a first direction and a fluid which exerts a force against the movable member in a second direction opposite to the first direction.

### BACKGROUND

Torque transmission apparatus such as brakes and clutches generally employ relatively rotatable members which are frictionally engaged to absorb and transmit kinetic energy. They are commonly involved in the mechanical transmission of a vehicle. For instance, a clutch is commonly used for engaging or disengaging the mechanical transmission from the engine to the wheel of the vehicle when the driver shifts the gear thereby varying the speed and power of the vehicle, while a brake is commonly used for slowing or stopping the vehicle in an abrupt manner when the driver first presses the clutch pedal and then the brake pedal which disengages the supply of power from the engine to the transmission of the vehicle from its initial engaged position. However, during the braking or clutching operations, the contacting parts are subjected to wearing and in the long run, the key components are worn out. The mechanical transmission thus requires frequent maintenance.

### SUMMARY OF THE INVENTION

To solve or reduce at least some of the drawbacks associated with the conventional torque transmission apparatus, the present invention discloses a torque transmission apparatus comprises a cavity for retaining a fluid convertible between two physical states in response to application of a magnetic flux.

The present invention provides a torque transmission apparatus, comprising a stationary member, a movable member movable relative to the stationary member in a first direction, and a cavity defined between the stationary member and the movable member for retaining a fluid convertible between a default physical state during which the fluid exerts a force against the movable member in a second direction opposite to the first direction and a temporary physical state during which the force exerted against the movable member is reduced in response to application of a temporary magnetic flux.

In one embodiment, the fluid remains in the default physical state in response to a default magnetic flux applied thereto.

In one embodiment, the torque transmission apparatus further includes a magnetic regulating mechanism for manipulating the default magnetic flux thereby converting the fluid between the default physical state and the temporary physical state.

In one embodiment, the magnetic regulating mechanism manipulates position of the default magnetic flux.

In one embodiment, the magnetic regulating mechanism manipulates intensity of the default magnetic flux.

In one embodiment, the magnetic regulating mechanism includes a first magnetic source for applying the default magnetic flux thereby maintaining the fluid at the default physical state.

In one embodiment, the magnetic regulating mechanism further includes a second magnetic source for applying the temporary magnetic flux with which the default magnetic flux interacts thereby converting the fluid to the temporary physical state.

In one embodiment, the temporary magnetic flux shifts the default magnetic flux away from the fluid.

In one embodiment, the default magnetic flux is opposed by the temporary magnetic flux for eliminating the default magnetic flux applied to the fluid.

In one embodiment, the default physical state includes solid state.

In one embodiment, the temporary physical state includes one of liquid state and gas state.

In one embodiment, the first magnetic source includes a permanent magnet.

In one embodiment, the second magnetic source includes an electric coil.

In one embodiment, the viscosity of the fluid is manipulated by the magnetic regulating mechanism.

In one embodiment, the fluid includes a magnetorheological fluid.

In one embodiment, the stationary member is a stator and the movable member is a rotor rotatable with respect to the stator.

### BRIEF DESCRIPTION OF THE DRAWINGS

Embodiments of the present invention will now be described, by way of example, with reference to the accompanying drawings in which:

FIG. 1 shows the torque transmission apparatus in accordance with one embodiment of the present invention;

FIG. 2 is a side view of the torque transmission apparatus in FIG. 1 showing an axis A-A in accordance with one embodiment of the present invention;

FIG. 3 is a top view of the torque transmission apparatus in FIG. 1 in accordance with one embodiment of the present invention;

FIG. 4 is a bottom view of the torque transmission apparatus in FIG. 1 in accordance with one embodiment of the present invention;

FIG. 5 is an exploded view of the torque transmission apparatus in FIG. 1 in accordance with one embodiment of the present invention;

FIG. 6 is a cross-sectional view along axis A-A of the torque transmission apparatus in FIG. 2 in accordance with one embodiment of the present invention;

FIG. 7 is an enlarged cross-sectional view of the torque transmission apparatus in FIG. 6 in accordance with one embodiment of the present invention;

FIG. 8 is a schematic cross-sectional view of the torque transmission apparatus in response to application of a default magnetic flux in accordance with one embodiment of the present invention; and

FIG. 9 is another schematic cross-sectional view of the torque transmission apparatus in response to application of a temporary magnetic flux in accordance with one embodiment of the present invention.

### DETAILED DESCRIPTION OF THE PREFERRED EMBODIMENT

Without wishing to be bound by theories, the inventors, through their own trials and experiments, have devised that although a magnetorheological fluid (MR) fluid is suitable for mechanical transmissions applications, such active braking system is triggered by a current induced magnetic field and thus when the electricity supply is unstable, the braking system is somehow unsafe.

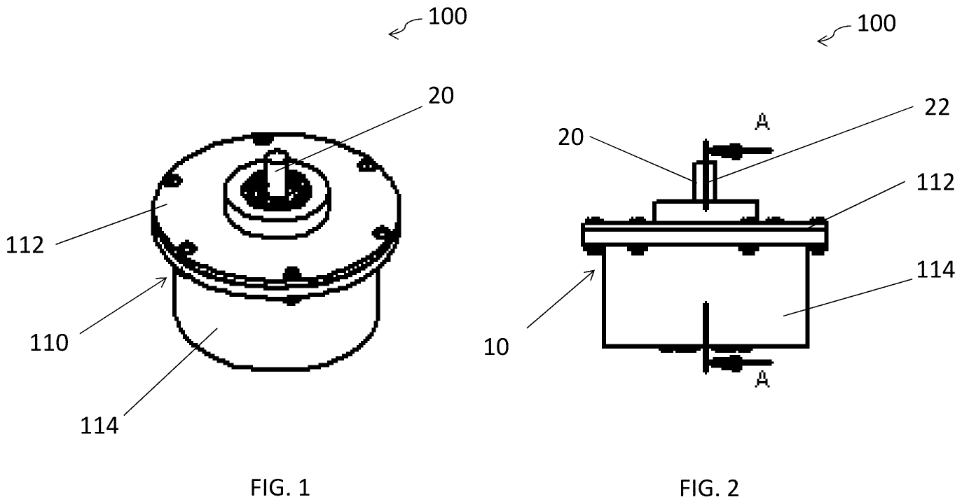

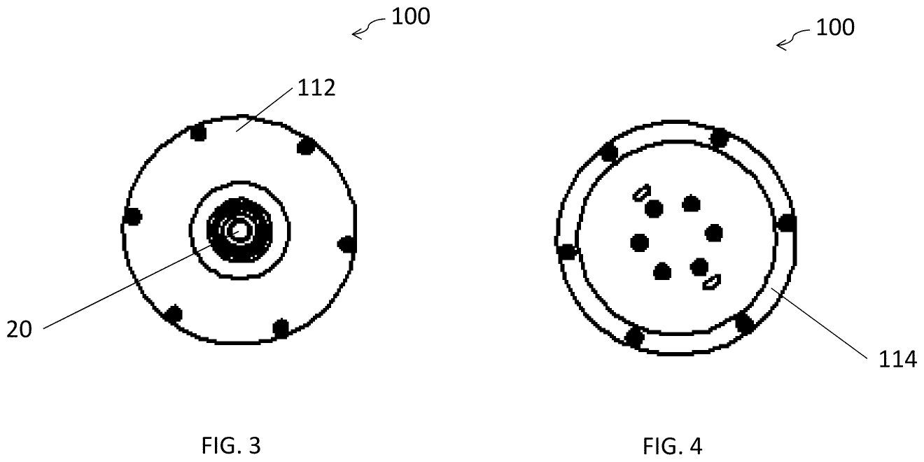

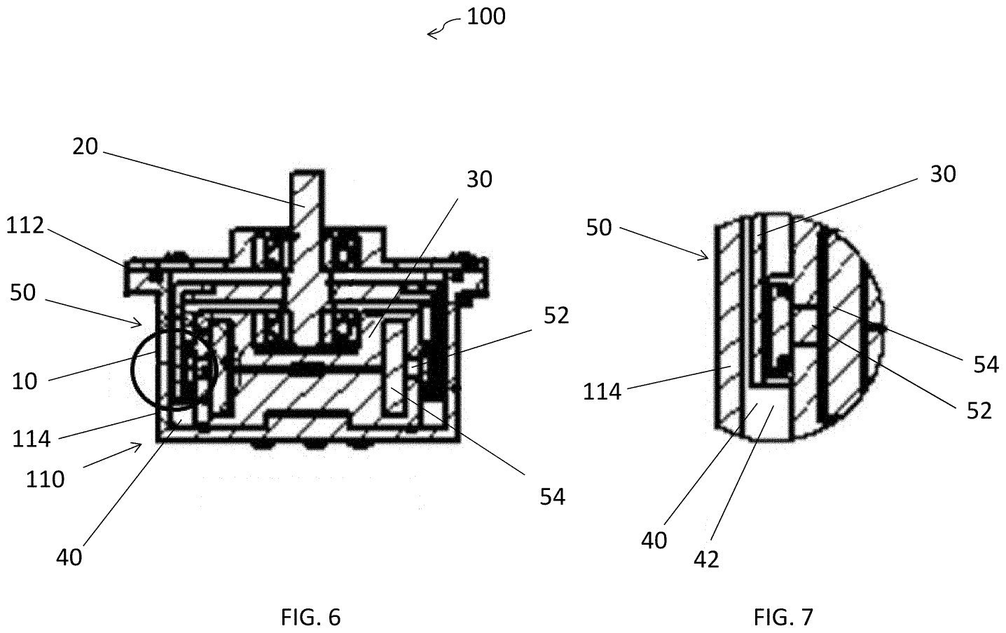

Referring initially to FIGS. 1 to 9, there is provided a torque transmission apparatus 100, comprising: a stationary member 10, a movable member 30 movable relative to the stationary member 10 in a first direction; a cavity 40 defined between the stationary member 10 and the movable member 30 for retaining a fluid 42 convertible between a default physical state during which the fluid 42 exerts a force against the movable member 30 in a second direction opposite to the first direction and a temporary physical state during which the force exerted against the movable member 30 is reduced in response to application of a temporary magnetic flux 55.

The torque transmission apparatus 100 may be incorporated as a brake or a clutch. With reference to the accompanying drawings FIGS. 1 to 9 in the present invention, the torque transmission apparatus is embodied as a brake 100. However, it will be appreciated by persons skilled in the art that the following descriptions and embodiments maybe be applied in any other applications such as in a clutch with minor modifications and without departing from the concept of the present invention.

With reference to FIGS. 1-4, there is provided a brake 100 that may be used for a movable device or apparatus, such as a vehicle, a vessel or an aeroplane etc. The brake 100 comprises: a stationary housing 110 defined by a shell cover 112 and a shell body 114; and a rotatable shaft 20 received within the housing 110, preferably positioned at the centre of the housing 110. The shaft 20 may extend through the shell cover 112 along a rotating axis 22, and may be connected to a wheel of a vehicle (not shown), such that altering the movement of the shaft 20 may in turn alter the movement of the wheel.

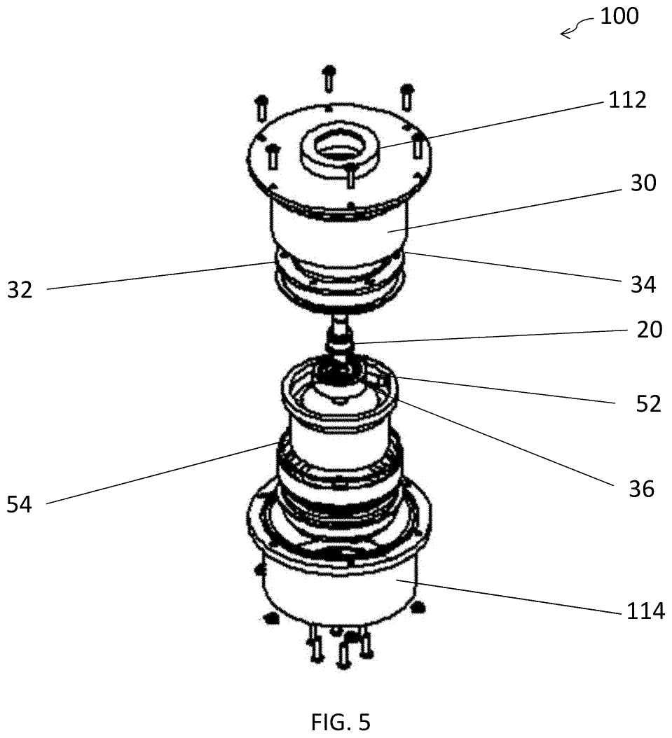

Turning now to FIGS. 5-7 for the detailed internal structure, the brake 100 further includes: a stationary member 10 forming part of the housing 110; a movable member 30 movable relative to the stationary member 10 where the movable member 30 is actuated by the shaft 20; and a cavity 40 defined between the stationary member 10 and the movable member 30 for retaining a fluid 42 therein.

In one embodiment, the stationary member 10 may be an additional member enclosed by the housing 110 serving as a stator, and the movable member 30 may be positioned within the stationary member 10 serving as a rotor rotatable with respect to the stator 10. The movable member 30 may include a disk 32 and a drum 34 for receiving the mechanical transmission from the shaft 20. The shaft 20 may be connected to the rotor via a shaft key 36 through which the shaft 20 may actuate the rotor 30 in response to the actuation by an engine.

In one embodiment, the brake 100 is further provided a magnetic regulating mechanism 50, preferably adjacent to the fluid 42 retained in the cavity 40, for regulating the magnetic flux interacting with the fluid 42. The magnetic regulating mechanism 50 may include two magnetic sources which in cooperation may selectively apply a magnetic flux to the fluid 42 during different phases. In the illustrated embodiment, the two magnetic sources may include a permanent magnet 52 and an electric coil 54. Both the permanent magnet 52 and the electric coil 54 are preferably annular-shaped and arranged within the rotor 30, such that the permanent magnet 52 as well as the electric coil 54 are positioned annularly about the rotor 30.

In one example embodiment, the illustrated permanent magnet 52 has a larger diameter than the electric coil 54, such that the permanent magnet 52 is positioned between the fluid 42 and the electric coil 54 and is positioned more proximate to the fluid 42 than the electric coil 54. The illustrated permanent magnet 52 has a shorter height than the electric coil 54, in order to provide an appropriate intensity of magnetic flux 53. Alternatively, as understood by those skilled in the art, a permanent magnet 52 with a different height or dimension may be utilized according to the desired intensity of the magnetic flux 53 to be applied to the fluid 42.

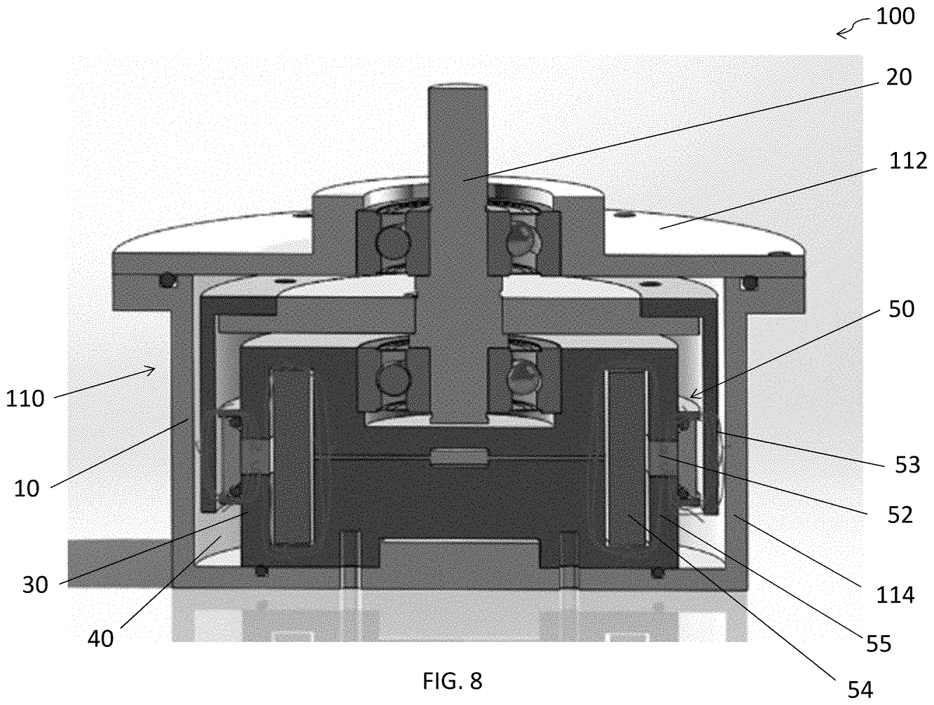

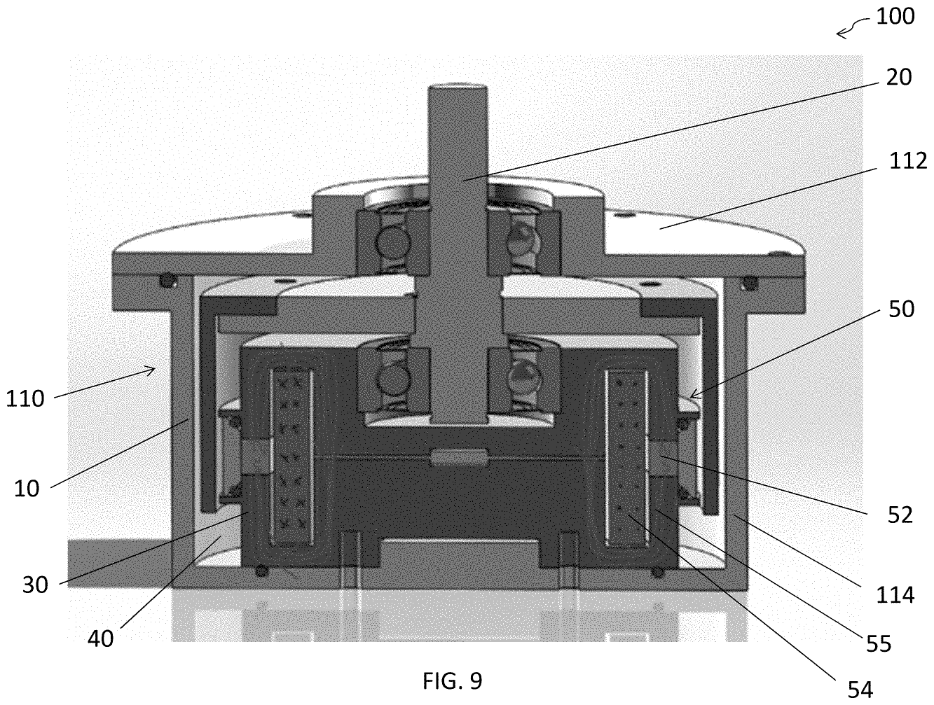

Referring finally to FIGS. 8 and 9 for the detailed explanation for the working principle of the magnetic regulating mechanism 50, the fluid 42 retained in the cavity 40 is convertible between two physical states a first, default physical state at which a high friction is exerted between the stator 10 and the rotor 30 and a second physical state at which a barely minimal friction if not frictionless is exerted between the stator 10 and the rotor 30.

The fluid 42 remains in a default physical state when a default magnetic flux 53 is applied to the fluid 42 by the permanent magnet 52, thus causing the fluid 42 to exert a significant force against the rotor 30 in a direction opposite to the rotation direction of the rotor 30, as shown in FIG. 8. The wheel of the vehicle thus remains stationary or decelerates if the vehicle is currently driven by an engine.

When a temporary magnetic flux 55 is applied by the electric coil 54 to the fluid 42, as shown in FIG. 9, the fluid 42 converts into a temporary physical state thus at least reducing the magnitude of the force exerted against the rotor 30 or reducing the force to a negligible magnitude i.e. no frictional force.

To manipulate the physical state of the fluid 42, the default magnetic flux 53 is maintained by the permanent magnet 52 while the temporary magnetic flux 55 is selectively generated by the electric coil 54. Preferably, the fluid 42 is a magnetorheological fluid which contains a suspension of magnetizable particles in a carrier fluid 42. When subjected to the default magnetic flux 53 generated by the permanent magnet 52, the magnetorheological fluid 42 increases its apparent viscosity and becomes a viscoelastic solid. By varying the magnetic field intensity, the yield stress of the fluid 42 can be controlled accurately such that the engaging and disengaging between the stator 10 and the rotor 30 may occur progressively.

The default magnetic flux 53 is manipulated by the permanent magnet 52; the temporary magnetic flux 55 is manipulated by the electric coil 54. The permanent magnet 52 is positioned between the fluid 42 and the electric coil 54, generating the default magnetic flux 53 which in turn converting the fluid 42 to a solid state in the default state without current passing through the electric coil 54. When current is passed through the electric coil 54 (i.e. when there is electricity provided to the brake 100), the temporary magnetic flux 55 is generated which in turn converting the fluid 42 to a liquid state or a gas state in the temporary state.

In other words, in the default state when no electricity is supplied to the brake 100, thus the electric coil 54, the fluid 42 remains in the solid state and the brake 100 functions as a device which inhibits the motion of the moving system (e.g. the vehicle), so that the moving system is stationary. When a movement of the moving system is desired, the user may supply electricity to the brake 100 for instance by depressing the pedal, thus turning the fluid 42 to a liquid or gas and disabling the braking function.

The magnetic field lines of the default magnetic flux 53 generated by the permanent magnet 52 are shown in FIG. 8. The default magnetic flux 53 has an effect on the physical state of the fluid 42 retained in the cavity 40, thereby changing the physical state of the fluid 42 and maintaining the fluid 42 at a solid state. However, as shown in FIG. 9, when current is provided to the electric coil 54, the temporary magnetic flux 55 has an effect on the physical state of the fluid 42 retained in the cavity 40, thereby temporarily changing the physical state of the fluid 42 and converting the fluid 42 to a liquid or gas state.

In one embodiment, the permanent magnet 52 and the electric coil 54 manipulate the position of the default magnetic flux 53. The induced current generates a temporary magnetic field 55 that changes the position of the default magnetic flux 53 by means of shifting the default magnetic flux 53 away from the fluid 42. As such, the default magnetic flux 53 no longer interacts with the fluid 42, so the fluid 42 is converted into a liquid state or a gas state.

In an alternative embodiment, the permanent magnet 52 and the electric coil 54 manipulate the intensity of the default magnetic flux. When current is passed through the electric coil 54, the temporary magnetic flux 55 generated by the electric coil 54 generally has a greater intensity compared with that of the default magnetic flux 53 generated by the permanent magnet 52. Therefore, the weaker default magnetic flux 53 is opposed by the stronger temporary magnetic flux 55, thereby eliminating the default magnetic flux 53 applied the fluid 42. As such, the effect of the default magnetic flux 53 on the fluid 42 is overshadowed by the effect of the stronger temporary magnetic flux 55, so the fluid 42 in the solid state turns into the liquid or gas state upon the supply of electricity to the electric coil 54.

In yet another embodiment, the torque transmission apparatus 100 may be embodied as a clutch (not shown), which could be used in an engine as a car clutch to separate the driving shaft i.e. the flywheel of the engine from the driven shaft in a vehicle. The clutch plays a vital role to decouple the engine from mechanical transmission so that no torque is transferred and the gears can be shifted easily by the driver. By fixing the driven shaft against the rotation, a clutch can also act as a brake or a speed reducing means on the driving shaft.

In this embodiment, the working principal of the clutch is very similar to that of the aforementioned brake 100. In a clutch mechanism, there is provided two rotating shafts, one of which being a driving shaft and the other of which being a driven draft. The clutch, by positioned one shaft proximate to the other shaft separated by a MR fluid containing cavity, allows selective coupling and decoupling of the two shafts. The shafts may be coupled together to rotate at the same speed, partially coupled to rotate at different speeds, or completely decoupled, dependent upon the state of the fluid positioned between the shafts.

In a default state when electric current is not applied to the clutch, the fluid in the cavity between the two shafts are in the default physical state (i.e. solid state) due to the presence of the default magnetic flux generated by the permanent magnet. When the two shafts come in contact with each other through the solidified MR fluid, they rotate as a single unit, thereby allowing the rotary motion of the driving shaft to be transmitted to the driven shaft.

Before the driver shifts the gear, he initially depresses the pedal and a current is induced to generate a temporary magnetic flux via the electric coil, thereby manipulating the default magnetic flux to interact with the temporary magnetic flux generated by the electric coil, thus temporarily changing the physical state of the fluid from the solid state to the liquid or gas state. This in turn disengages the mechanical transmission of the two shafts such that the driven shaft does not rotate with the driving shaft, and thereby allowing the gears to shift to vary the speed and power of the vehicle.

When the driver is satisfied with the speed and/or power of the vehicle and does not want to change the gear ratio any further, the driver may release the pedal and interrupt the electric current applied to the clutch, thereby restoring the default magnetic flux, thus restoring the physical state of the fluid from the temporary liquid or gas state to the solid state. As a result, the driven shaft will rotate with the driving shaft and the mechanical transmission of the two shafts is engaged.

The present invention, as discussed above, provides a torque transmission apparatus 100 (e.g. a brake or a clutch) with a safer operation compared with the conventional torque transmission apparatus which functions upon the supply of electricity. This is particularly useful when a fault or power shortage in the moving system (e.g. a vehicle) is experienced. In such situations using a conventional electromagnetic brake when the driver wants to slow down or to stop the vehicle by applying electric current to the brake, the vehicle to which the brake is connected may continue to move. This is dangerous especially when the vehicle is on an inclined slope. On the other hand, as described herein, where there is a power shortage and no electric current is applied to the brake, the present torque transmission apparatus can still function properly to prevent the vehicle's motion as desired.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A torque transmission apparatus, comprising:
a stationary member;
a movable member movable relative to the stationary member in a first direction;
a cavity defined between the stationary member and the movable member for retaining a fluid convertible between a default physical state during which the fluid exerts a force against the movable member in a second direction opposite to the first direction and a temporary physical state during which the force exerted against the movable member is reduced in response to application of a temporary magnetic flux.

2. A torque transmission apparatus in accordance with claim 1, wherein the fluid remains in the default physical state in response to a default magnetic flux applied thereto.

3. A torque transmission apparatus in accordance with claim 2, further including a magnetic regulating mechanism for manipulating the default magnetic flux thereby converting the fluid between the default physical state and the temporary physical state.

4. A torque transmission apparatus in accordance with claim 3, wherein the magnetic regulating mechanism manipulates position of the default magnetic flux.

5. A torque transmission apparatus in accordance with claim 3, wherein the magnetic regulating mechanism manipulates intensity of the default magnetic flux.

6. A torque transmission apparatus in accordance with claim 3, wherein the magnetic regulating mechanism includes a first magnetic source for applying the default magnetic flux thereby maintaining the fluid at the default physical state.

7. A torque transmission apparatus in accordance with claim 6, wherein the magnetic regulating mechanism further includes a second magnetic source for applying the temporary magnetic flux with which the default magnetic flux interacts thereby converting the fluid to the temporary physical state.

8. A torque transmission apparatus in accordance with claim 7, wherein the temporary magnetic flux shifts the default magnetic flux away from the fluid.

9. A torque transmission apparatus in accordance with claim 7, wherein the default magnetic flux is opposed by the temporary magnetic flux for eliminating the default magnetic flux applied to the fluid.

10. A torque transmission apparatus in accordance with claim 1, wherein the default physical state includes solid state.

11. A torque transmission apparatus in accordance with claim 1, wherein the temporary physical state includes one of liquid state and gas state.

12. A torque transmission apparatus in accordance with claim 6, wherein the first magnetic source includes a permanent magnet.

13. A torque transmission apparatus in accordance with claim 7, wherein the second magnetic source includes an electric coil.

14. A torque transmission apparatus in accordance with claim 3, wherein the viscosity of the fluid is manipulated by the magnetic regulating mechanism.

15. A torque transmission apparatus in accordance with claim 1, wherein the fluid includes a magnetorheological fluid.

16. A torque transmission apparatus in accordance with claim 1, wherein the stationary member is a stator and the movable member is a rotor rotatable with respect to the stator.
